(19) United States
(12) Patent Application Publication
(10) Pub. No.: US 2015/0006205 A1
(43) Pub. Date: Jan. 1, 2015

(54) SYSTEM AND METHOD PROVIDING AUTOMOBILE INSURANCE RESOURCE TOOL

(71) Applicants: Christopher Corey Chase, Peoria, AZ (US); Justin R. Clifton, Indianapolis, IN (US); David J. Kuethman, Wethersfield, CT (US); Keith A. Lyons, Longwood, FL (US); Veronica Mayorga, Hondo, TX (US); Andres Pelaez, Westfield, IN (US); Anthony J. Phifer, Zionsville, IN (US); Nicholas Christian Sherriff, Lithia, FL (US)

(72) Inventors: Christopher Corey Chase, Peoria, AZ (US); Justin R. Clifton, Indianapolis, IN (US); David J. Kuethman, Wethersfield, CT (US); Keith A. Lyons, Longwood, FL (US); Veronica Mayorga, Hondo, TX (US); Andres Pelaez, Westfield, IN (US); Anthony J. Phifer, Zionsville, IN (US); Nicholas Christian Sherriff, Lithia, FL (US)

(21) Appl. No.: 13/930,851

(22) Filed: Jun. 28, 2013

(51) Int. Cl. G06Q 40/08

(52) U.S. Cl. CPC G06Q 40/08
USPC 705/4

(57) ABSTRACT

According to some embodiments, an automobile insurance resource platform may interact with a claim professional via a graphical user interface tool, and input data associated with an automobile insurance claim is received from the claim professional. Compliance information may be received from the claim professional via a regulation compliance checklist interface, and action plan information may be automatically created. An indication of the action plan information may then be displayed to the claim professional via a compliance issue area in a resolution interface of the graphical user interface tool.

### BACKGROUND

A claim professional working for an insurer may help process an automobile insurance claim and document the steps have been, and will be, taken to resolve the claim. For example, the claim professional might make a telephone call to discuss insurance coverage with a claimant and note in a claim file (e.g., an electronic record associated with the claim) that this step has been performed. Note that an automobile insurance claim may be associated with a number of different processing steps (e.g., a coverage determination, a liability assessment, a damages calculation, and an ultimate resolution) and each step may require documentation of a number of different types of data. Moreover, different claim professionals may record data in different ways. For example, different claim professionals might place items in different orders, use different abbreviations or templates, etc. As a result, claim files may be inconsistently formatted and difficult to read and/or evaluate. In addition, copying information from various word processing programs, macros, automated calculators, etc., can be a time-consuming and complicated task for a claim professional (e.g., because different jurisdictions may be associated with different insurance requirements), especially when there are a substantial number of claims to be processed. It would therefore be desirable to provide systems and methods to facilitate entry of automobile insurance claim data in an automated, efficient, and consistent manner.

### SUMMARY OF THE INVENTION

According to some embodiments, systems, methods, apparatus, computer program code and means may provide a tool to facilitate entry of automobile insurance claim data. In some embodiments, an automobile insurance resource platform may interact with a claim professional via a graphical user interface tool, and input data is received from the claim professional. The input data is associated with an automobile insurance claim and includes compliance information provided via a regulation compliance checklist interface. Action plan information may then be automatically created by the automobile insurance resource platform based on the received compliance information. An indication of the action plan information may then be displayed to the claim professional via a compliance issue area in a resolution interface of the graphical user interface tool.

Some embodiments provide: means for interacting, at a computer processor of an automobile insurance resource platform, with a claim professional via a graphical user interface tool; means for receiving input data from the claim professional, the input data being associated with an automobile insurance claim and including compliance information provided via a regulation compliance checklist interface; means for automatically creating, by the computer processor of the automobile insurance resource platform, action plan information based on the compliance information; and means for displaying an indication of the action plan information to the claim professional via a compliance issue area in a resolution interface of the graphical user interface tool.

A technical effect of some embodiments of the invention is an improved and computerized method to facilitate entry of automobile insurance claim data. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 illustrates an automobile insurance graphical user interface according to some embodiments.

FIG. 3 illustrates a method that might be performed in accordance with some embodiments.

FIG. 4 illustrates a note interface according to some embodiments of the present invention.

FIGS. 5A and 5B illustrate coverage interfaces according to some embodiments of the present invention.

FIG. 6 illustrates a liability interface according to some embodiments of the present invention.

FIG. 7 illustrates a damages interface according to some embodiments of the present invention.

FIG. 8 illustrates a resolution interface according to some embodiments of the present invention.

FIG. 9 illustrates a links interface according to some embodiments of the present invention.

FIG. 10 illustrates a tools interface according to some embodiments of the present invention.

FIG. 11 illustrates a regulation compliance menu according to some embodiments of the present invention.

FIG. 12 is block diagram of an automobile insurance resource tool or platform according to some embodiments of the present invention.

FIG. 13 is a tabular portion of a claims database according to some embodiments.

FIG. 14 illustrates a handheld tablet display in accordance with some embodiments described herein.

### DESCRIPTION

A claim professional working for an insurer may help process an automobile insurance claim and document the steps have been, and will be, taken to resolve the claim. For example, the claim professional might determine and record in a claim file a geographic location where an automobile accident occurred (e.g., “NY”). Note that an automobile insurance claim may be associated with various processing steps that each requires documentation of multiple data elements that might be recorded by different claim professionals in different ways. Moreover, manually copying information from various word processing programs, macros, automated calculators, etc., can be a time-consuming and complicated task for a claim professional, especially when there are a substantial number of claims to be processed.

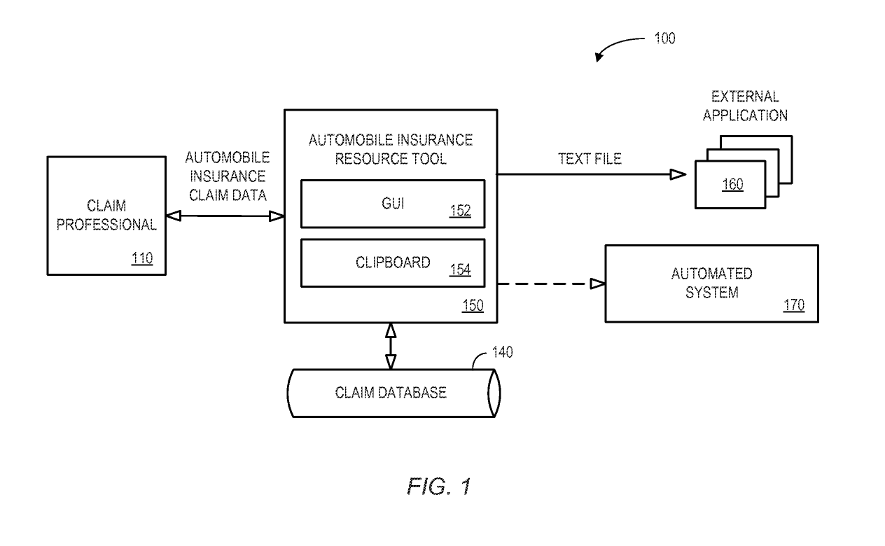

It would therefore be desirable to provide systems and methods to facilitate entry of automobile insurance claim data in an automated, efficient, and consistent manner. FIG. 1 is block diagram of a system 100 according to some embodiments of the present invention. In particular, the system 100 includes an automobile insurance resource tool 150 that receives automobile insurance claim data from a claim professional 110. According to some embodiments, the automobile insurance resource tool 150 may also receive information, such as an electronic file, from a client, an employee or insurance agent, or a claim database 140. The automobile insurance resource tool 150 might be, for example, associated with a Personal Computers (PC), laptop computer, an enterprise server, a server farm, and/or a database or similar storage devices. The automobile insurance resource tool 150 may, according to some embodiments, be associated with a business organization or an insurance provider.

According to some embodiments, an “automated” automobile insurance resource tool 150 may facilitate entry of automobile insurance claim data using a Graphical User Interface (“GUI”) 152. As used herein, the term “automated” may refer to, for example, actions that can be performed with little or no human intervention. The claim professional 110 may interact with the graphical user interface 152 to create a text file that can be provided to an external application 160, such as a claims processing application. According to some embodiments, the automobile insurance resource tool 150 places the text file in an Operating System (“OS”) clipboard 154 to transfer the text file. The automobile insurance resource tool 150 might also transmit information to an automated system 170, such as a report generator, workflow application, or email notification system.

As used herein, devices, including those associated with the automobile insurance resource tool 150 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The automobile insurance resource tool 150 may store information into and/or retrieve information from the claim database 140. The claim database 140 may be locally stored or reside remote from the automobile insurance resource tool 150. Although a single automobile insurance resource tool 150 is shown in FIG. 1, any number of such devices may be included. Moreover, various devices described herein might be combined according to embodiments of the present invention. For example, in some embodiments, the claim automobile insurance resource tool 150, claim database 140, and external application 160 might be co-located and/or may comprise a single apparatus. Note that the database 140 may be used as a short-term storage device and that claim information may be copied and/or exported to an external claim processing application 160 for long-term storage.

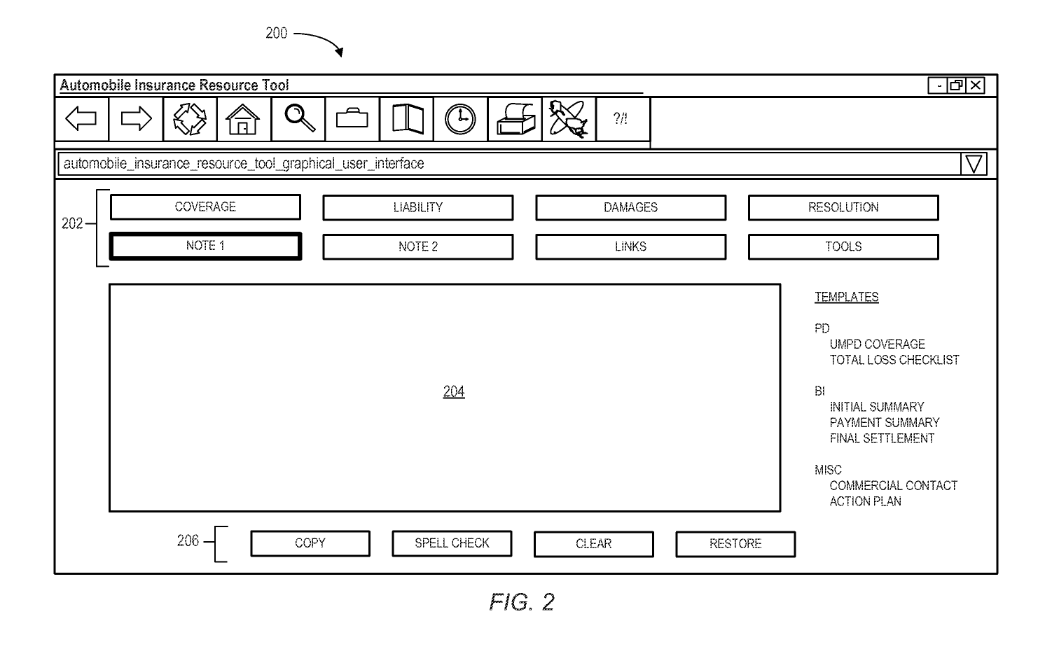

According to some embodiments, the claim professional 110 accesses the automobile resource tool 150 via the GUI 152. For example, FIG. 2 illustrates an automobile insurance resource tool GUI 200 according to some embodiments. The GUI 200 includes selections 202 that may be used by a claim profession to access various specialized interfaces associated with insurance coverage, liability, damages, resolution, links and tools. The GUI 200 also includes a data entry area 204 where the claim professional may enter information about an automobile insurance claim (e.g., via a simple text editor). Further, the GUI 200 includes additional selections 206 to let the claim professional copy the data entry area 204 (e.g., by placing text in an OS clipboard), spell check the information, clear the data entry area 204, and/or restore previously entered data.

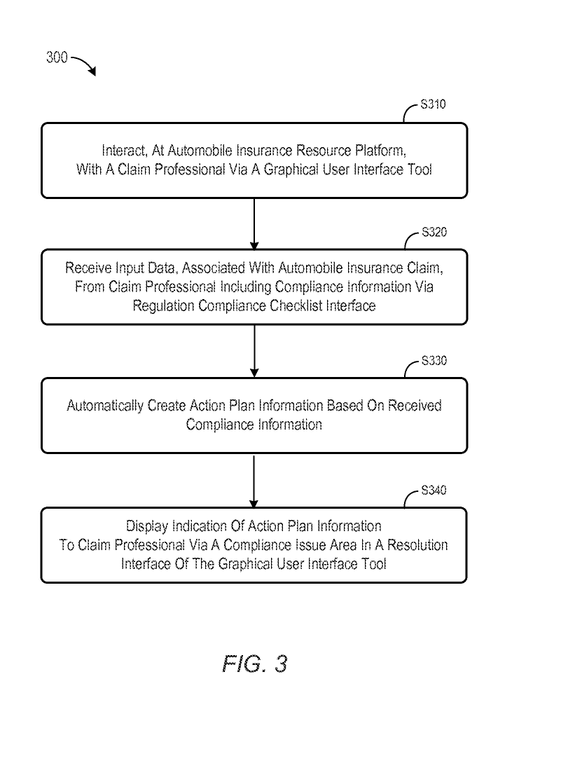

The claim profession can use the GUI 200 to create and update an automobile insurance claim file in accordance with any of the embodiments described herein. For example, FIG. 3 illustrates a method that might be performed by some or all of the elements of the system 100 described with respect to FIG. 1. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

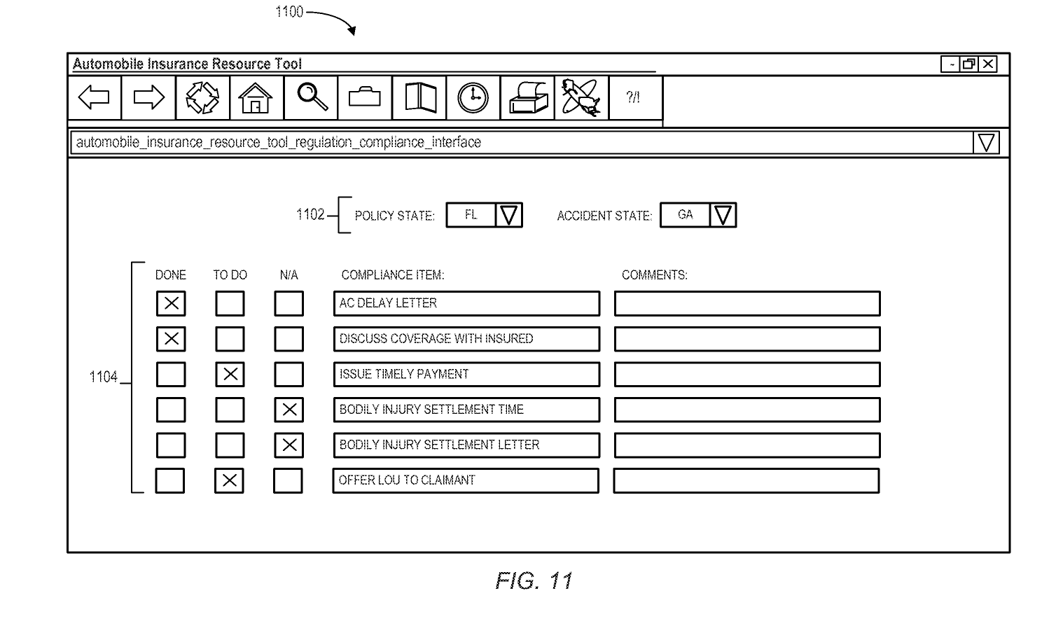

At S310, a claim professional interacts with an automobile insurance resource platform via a graphical user interface tool. For example, the claim professional may, at S320, provide input data associated with an automobile insurance claim, including compliance information provided via a regulation compliance checklist interface. One example of such a regulation compliance checklist interface is described herein in connection with FIG. 11. According to some embodiments, the input data may also include a geographic location associated with the automobile insurance claim. The geographic location might comprise, for example, an insurance policy state (e.g., where the automobile insurance policy was issued) and/or an accident state (e.g., in which the automobile accident occurred).

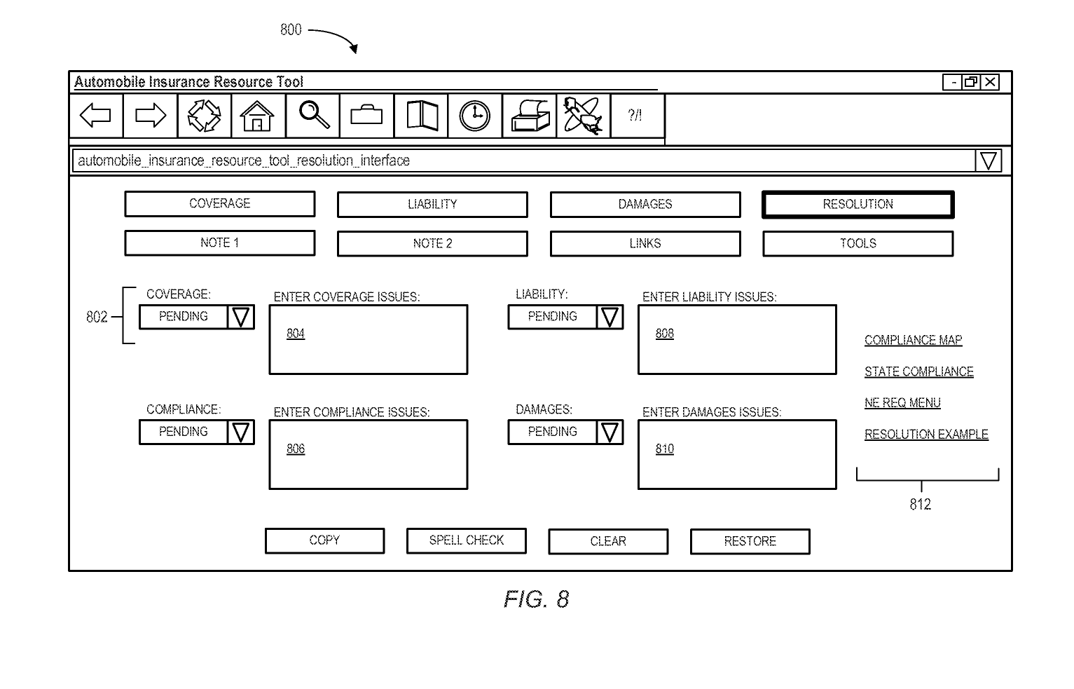

At S330, action plan information is automatically created based on the received compliance information. The action plan information may, for example, include steps that should be taken to process the automobile insurance claim efficiently, accurately, and in compliance with applicable laws and/or regulation. According to some embodiments, an insurance coverage issue may also be automatically determined based at least in part on the geographic location associated with the automobile insurance claim and at least one insurance coverage rule. For example, it might be determined that the state in which the accident occurred has different insurance requirements as compared to the state where the insurance policy was issued. At S340, an indication of the action plan information is displayed to the claim professional via a compliance issue area in a resolution interface of the graphical user interface tool. One example of such a resolution interface is described herein in connection with FIG. 8. According to some embodiments a determined coverage issue is also displayed to the claim professional via the graphical user interface tool. As a result, the entry of automobile insurance claim data may be facilitated.

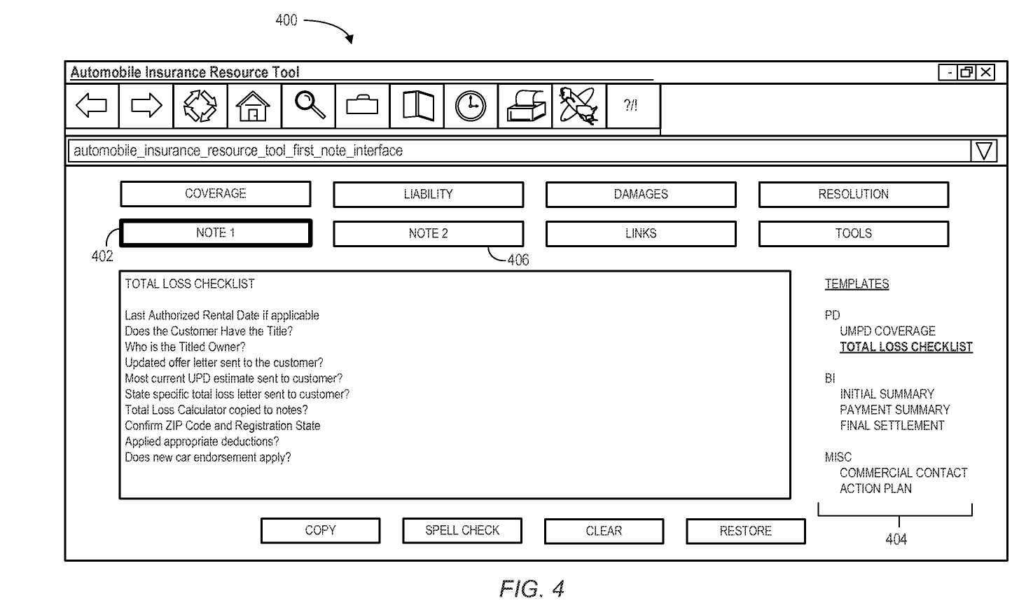

In additional to automatically creating action plan information and/or detecting insurance coverage issues, the graphical user interface may facilitate a consistent entry of insurance claim data. For example, FIG. 4 illustrates a note interface 400 that may be provided by an automobile insurance resource tool according to some embodiments of the present invention. In particular, a claim profession has selected a “Note 1” icon 402 on the interface 400 (as indicated by the bold outline in FIG. 4). The note interface 400 includes a set of templates 404 that may be selected by a user. In the example of FIG. 4, the claim profession has selected a “Total Loss Checklist” template 404 and, as a result, various items have been automatically placed in the text entry area of the note interface (“Last Authorized Rental Date if applicable,” “Does the Customer Have the Title?” etc.). Claim profession can then easily update the text information as appropriate, copy the text to a clipboard, and then export the information to an external application, such as a claims processing application, in a consistent manner. According to some embodiments, data in the note interface 400 is automatically populated with data received from the claim professional via other interfaces of the graphical user interface tool. Moreover, according to some embodiments, the graphical user interface tool includes a second note interface, selectable via a “Note 2” icon 406, that is independent of the first note interface (e.g., claim professionals can multitask by switching between the two notes without losing any of the entered information). According to some embodiments, the note interface 400 may provide a character count value (not illustrated in FIG. 4) indicating how many additional text characters can be added by a claim profession before a maximum value limit is reached.

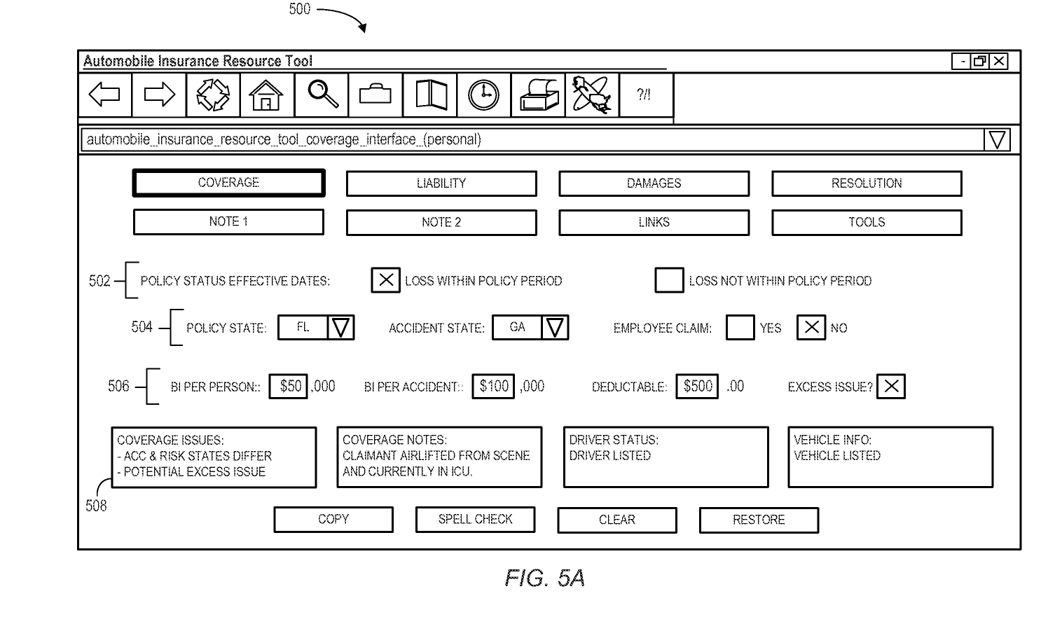

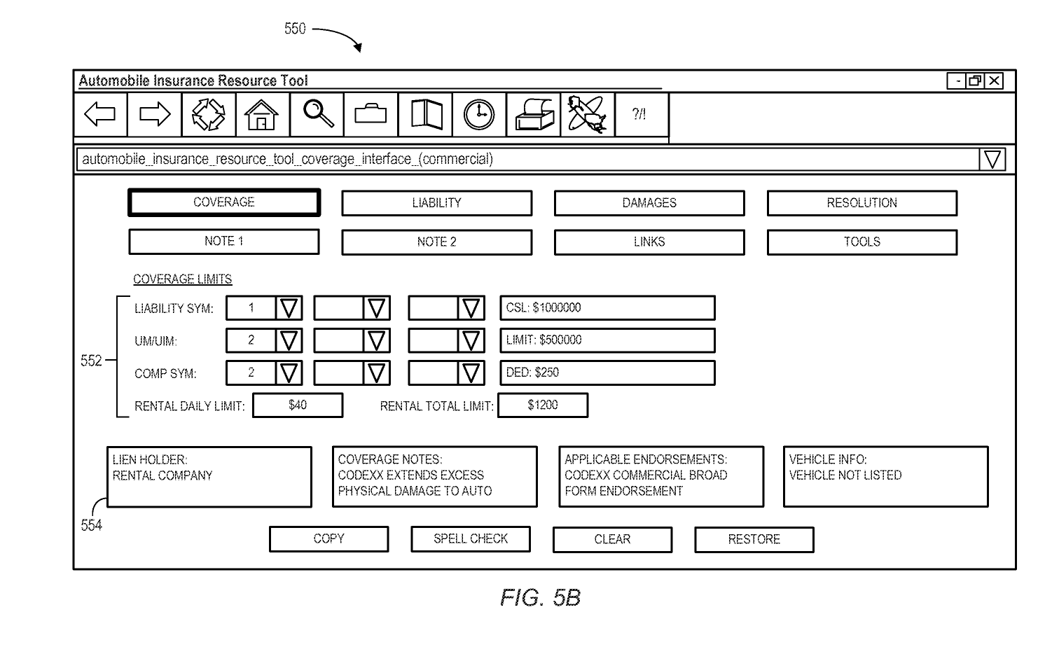

In addition to the templates 404, the graphical user interface tool may facilitate an exchange of insurance coverage information with a claim professional. For example, FIG. 5A illustrates a coverage interface 500 that might be used at the onset of a claim processing method for a personal automobile insurance claim according to some embodiments of the present invention. In particular, the coverage interface 500 may receive from the claim professional: personal insurance information, insurance information policy status effective dates 502 (e.g., whether or not the loss occurred while the insurance policy as in effect), vehicle information (e.g., whether or not the vehicle is listed in the insurance policy), geographic locations 504 of the policy state and the accident state, coverage limits 506 (for Bodily Injury (“BI”), deductible amounts, etc.), a driver status (e.g., whether or not the driver is listed in the insurance policy, coverage issues 508 (e.g., automatically determined based on the geographic locations 504), applicable endorsement information, and coverage notes. When the claim professional selects the “copy” icon, the information in the coverage interface 500 is automatically converted to a text file and placed in the OS clipboard. The conversion may place the information in a consistent easy to read format that incorporates the best elements of claim professional practice. This consistency may reduce training needs for an insurer. According to some embodiments, the coverage interface may further include commercial policy information (e.g., associated with multiple vehicles and/or drivers) as illustrated by the commercial coverage interface 550 illustrated in FIG. 5B. The commercial coverage interface 550 may include coverage limits 552 (e.g., a liability symbol, uninsured motorist information, and/or a collision symbol) and rental daily and total limits. According to some embodiments, the commercial coverage interface 550 also includes an indication of a lien holder 554 associated with the commercial automobile insurance claim.

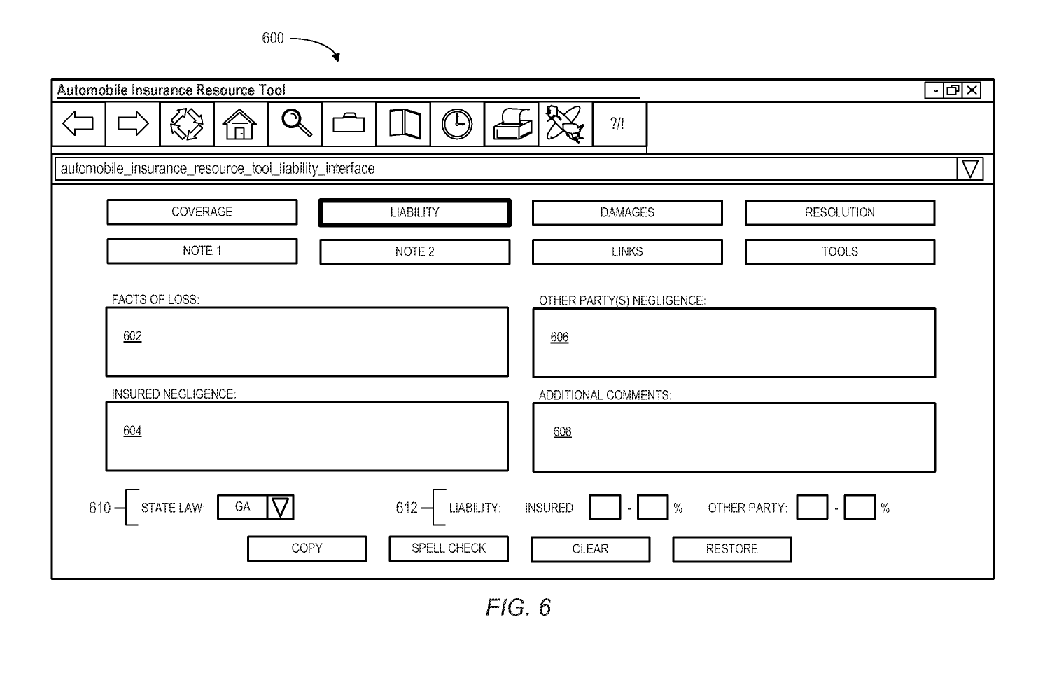

FIG. 6 illustrates a liability interface 600 according to some embodiments of the present invention. The liability interface 600 may include, for example, facts of loss 602, insured negligence 604 (e.g., duties owed, duties breached, and/or proximate causes), other party(s) negligence 606, and additional comments (e.g., motor vehicle statutes, weather conditions, and/or road hazards).

The liability interface may further include a drop-selection of applicable state law 610. According to some embodiment, percent ranges of liability 612 may be entered for the parties. Moreover, the automobile insurance resource tool or platform might automatically calculate some of these ranges of liability 612. For example, if a claim profession enters that the insured was between 25% and 50% liable, the automobile insurance resource tool might automatically enter 50% and 75% as the other party's range of liabilities. According to some embodiments, the claim professional may also access an “Example” of liability information via the liability interface 600.

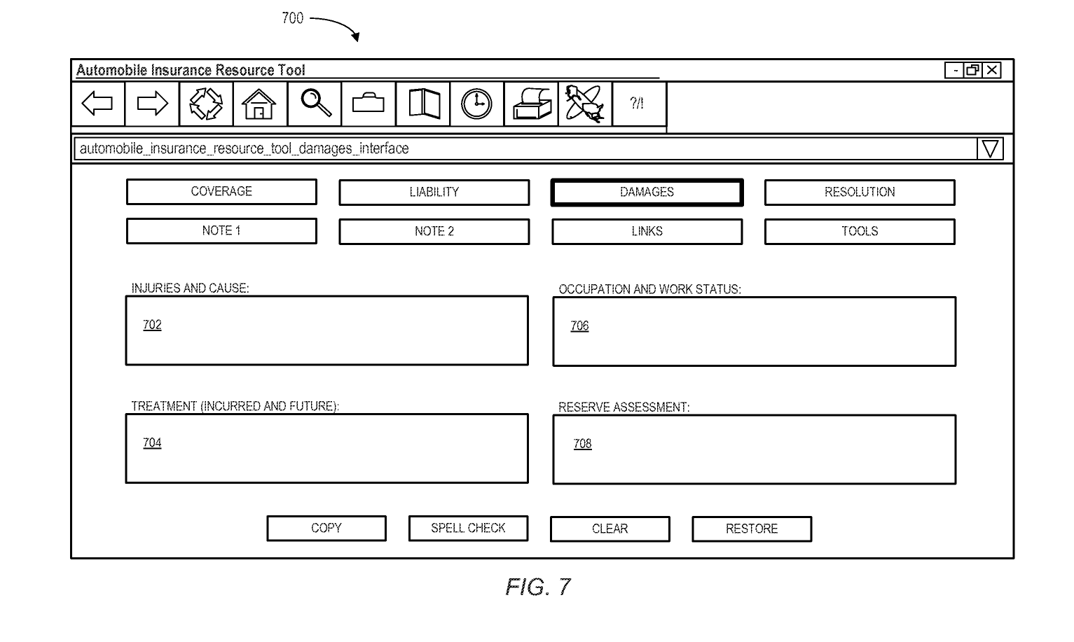

FIG. 7 illustrates a damages interface 700 for an automobile insurance resource platform according to some embodiments of the present invention. The damages interface 700 might be used, for example, to enter a description of injuries and cause 702, a description of incurred and future treatments 704, a description of occupation and work status 706, and a reserve assessment 708. The damages interface 700 may help the claim professional's initial analysis of the claim injury and the trajectory of claim handle during early stages of a claim handling process. For example, the claim professional might analyze causation, assess what the insurer knows, and list further information that the insurer that the insurer should acquire. When the claim professional selects the “copy” icon, the information in the damages interface 500 is automatically converted to a text file and placed in the OS clipboard.

FIG. 8 illustrates a resolution interface 800 according to some embodiments of the present invention. The resolution information may help a claim professional create a comprehensive, highly-defined action plan for the claim file. For example, the claim professional might select that insurance coverage issues status 802 is “pending” via a drop-down menu and then enter details about those coverage issues via coverage text entry area 804 of the interface 800 (e.g., “get copy of other parties insurance policy”). The claim professional might instead select that insurance coverage issues status 802 is “resolved” or “not applicable” via the drop-down menu (in which case the coverage text entry area 804 might be automatically removed from the display). Similarly areas are provided in the resolution interface 800 for compliance issues 806 (e.g., “issue payment within five days”), liability issues 808 (e.g., “obtain police report”), and damages issues 810 (e.g., receive estimate from mechanic”). According to some embodiments, automatically created action plan information may be automatically placed in the compliance text entry area 806 based on information provided by the claim professional via a regulation compliance checklist (e.g., as described in connection with FIG. 11). Similarly, information may be automatically placed in the coverage text entry area 804 (based on information provided via the personal coverage interface 500 and/or the commercial coverage interface 550), the liability text entry area 808 (based on information provided via the liability interface 600), and/or the damages text entry area 810 (based on information provided via the damages interface 700).

When the claim professional selects the “copy” icon, the information in the resolution interface 500 is automatically converted to a text file and placed in the OS clipboard. Other information that might be provided on the resolution interface includes, for example, associated timeframes for resolution, vehicle passenger information, a litigation plan status, whether or not coverage was discussed with the insured, and/or a description of litigation plan issues. According to some embodiments, links to other resources 812 are also provided on the resolution interface 800, such as links to compliance maps, example resolutions, etc.

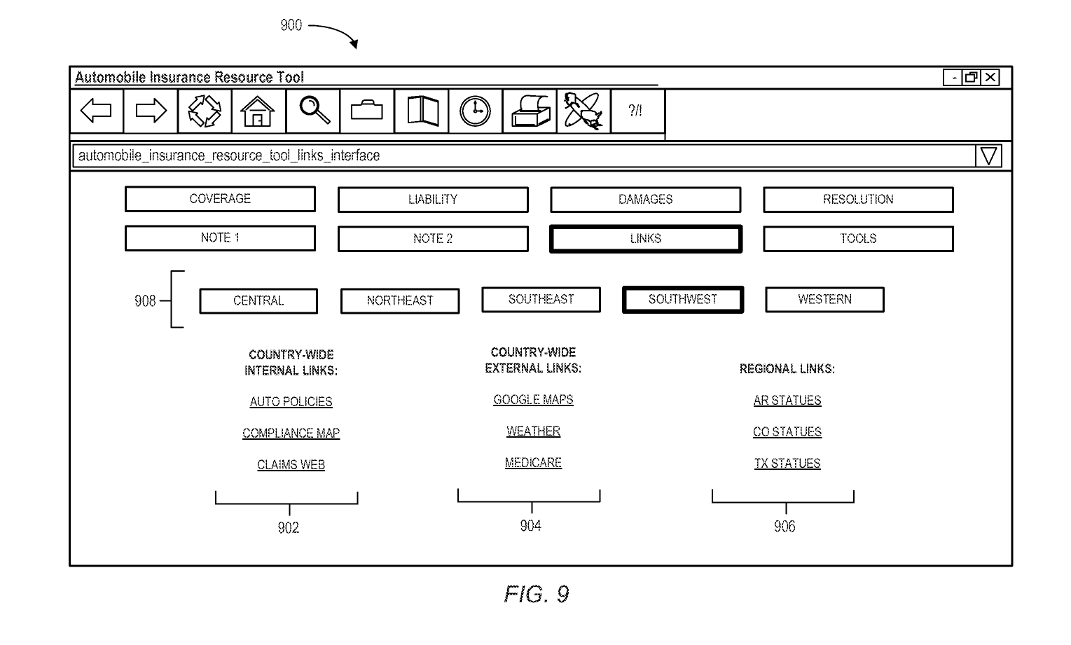

FIG. 9 illustrates a links interface 900 according to some embodiments of the present invention. The links interface 900 may include Uniform Resource Locator (“URL”) address links to country-wide internal web pages 902 (e.g., internal to the insurer) and country-wide external web pages 904 (e.g., Google® maps and a historical weather database). According to some embodiments, the links interface 900 also displays a set of custom-defined regional links 906. For example, the claim professional might select a region icon 908 to receive an appropriate set of regional links 906.

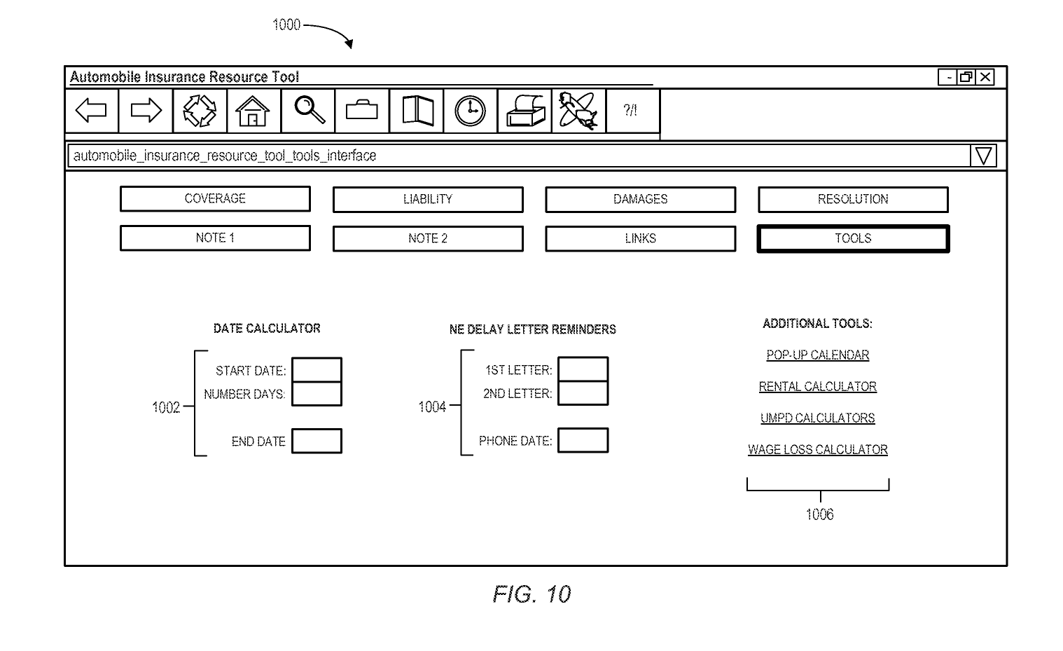

FIG. 10 illustrates a tools interface 1000 according to some embodiments of the present invention. The tools interface 1000 may provide the claim professional with access to commonly needed items, such as a built-in date calculator 1002 (that is, built-into the automobile insurance resource tool itself), a built-in delay letter reminder application 1004, and links to other additional tools 1006 (e.g., a pop-up calendar, a rental cost calculator, an Uninsured Motorist Property Damage (“UMPD”) coverage calculator, and/or a wage loss calculator).

FIG. 11 illustrates a regulation compliance menu 1100 according to some embodiments of the present invention. The regulation compliance menu 1100 might be accessed, for example, via the links to other resources 812 provided on the resolution interface 800 described with respect to FIG. 8. The regulation compliance menu 1100 might include, for example, drop-down selections 1102 for an insurance claim's policy state and/or accident state. Based on these selections 1102, a list of compliance items 1140 might be automatically displayed to the claim professional along with “done,” “to-do,” and “not applicable” check-mark boxes. In this way, a claim professional may be able to easily see what has and hasn't been done with respect to a particular insurance claim file. The information provided in the regulation compliance menu 1100 may be used to automatically create action plan information for the claim professional (e.g., to facilitating processing of the automobile insurance claim).

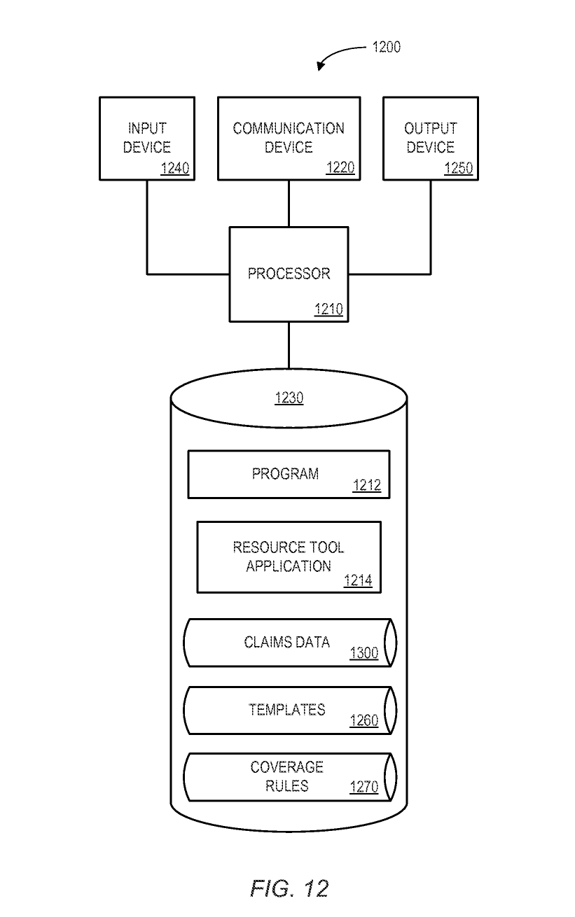

The embodiments described herein may be implemented using any number of different hardware configurations. For example, FIG. 12 illustrates an automobile insurance resource tool 1200 that may be, for example, associated with the system 100 of FIG. 1. The automobile insurance resource tool 1200 comprises a processor 1210, such as one or more commercially available Central Processing Units (CPUs) in the form of one-chip microprocessors, coupled to a communication device 1220 configured to communicate via a communication network (not shown in FIG. 12). The communication device 1220 may be used to communicate, for example, with one or more remote devices. The automobile insurance resource tool 1200 further includes an input device 1240 (e.g., a mouse and/or keyboard to enter and adjust automobile insurance claim information) and an output device 1250 (e.g., a computer monitor to display a graphical user interface).

The processor 1210 also communicates with a storage device 1230. The storage device 1230 may comprise any appropriate information storage device, including combinations of magnetic storage devices (e.g., a hard disk drive), optical storage devices, mobile telephones, and/or semiconductor memory devices. The storage device 1230 stores a program 1212 and/or a resource tool application 1214 for controlling the processor 1210. The processor 1210 performs instructions of the programs 1212, 1214, and thereby operates in accordance with any of the embodiments described herein. For example, the processor 1210 may interact with a claim professional via a graphical user interface tool, and receive input data from the claim professional, the input data being associated with an automobile insurance claim and including compliance information provided via a regulation compliance checklist interface. Action plan information may then be automatically created by the processor 1210 based on the compliance information. An indication of the action plan information may then be displayed by the processor 1210 to the claim professional via a compliance issue area in a resolution interface of the graphical user interface tool.

The programs 1212, 1214 may be stored in a compressed, uncompiled and/or encrypted format. The programs 1212, 1214 may furthermore include other program elements, such as an operating system, clipboard application a database management system, and/or device drivers used by the processor 1210 to interface with peripheral devices.

As used herein, information may be “received” by or “transmitted” to, for example: (i) the automobile insurance resource tool 1200 from another device; or (ii) a software application or module within the automobile insurance resource tool 1200 from another software application, module, or any other source.

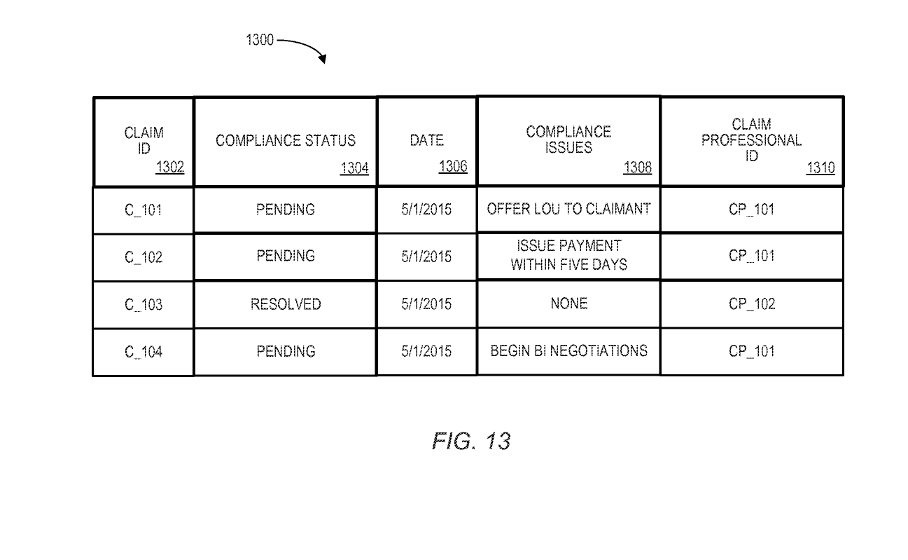

In some embodiments (such as shown in FIG. 9), the storage device 1230 further stores a claims data database 1300, templates 1270, and insurance coverage rules 1270. An example of a database that may be used in connection with the automobile insurance resource tool 1200 will now be described in detail with respect to FIG. 13. Note that the database described herein is only one example, and additional and/or different information may be stored therein. Moreover, various databases might be split or combined in accordance with any of the embodiments described herein. For example, the templates 1260 and/or coverage rules 1270 might be combined and/or linked to each other within the program 1212 and/or resource tool application 1214.

Referring to FIG. 13, a table is shown that represents the claims data database 1300 that may be stored at the automobile insurance resource tool 1200 according to some embodiments. The table may include, for example, entries identifying insurance claims submitted under a particular insurance policy or policies. The table may also define fields 1302, 1304, 1306, 1308, 1310 for each of the entries. The fields 1302, 1304, 1306, 1308, 1310 may, according to some embodiments, specify: a claim identifier 1302, a compliance status 1304, a date 1306, compliance issues 1308, and a claim professional identifier 1310. The claims data database 1300 may be created and updated, for example, based on information received from a claim professional.

The claim identifier 1302 may be, for example, a unique alphanumeric code identifying a claim submitted in connection with an automobile insurance policy. The compliance status 1304 might indicate whether compliance issues for that particular insurance policy are “pending” or “resolved.” The date 1306 might indicate when the compliance status 1304 was last updated, and the compliance issues 1308 might indicate what actions still need to performed by a claim professional associated with the claim professional identifier 1310.

Thus, embodiments described herein may provide claim professionals with a program to collect and organize auto claim documentation in one place that can be used in the day-to-day handling of automobile insurance claims. Such an approach may drive consistency in file documentation, improve customer service and state jurisdictional compliance, increase overall claim file quality, and provide links other resource tools/materials. Moreover, efficiency in the handling of insurance claims, claim professional training, and improved desk management may all be created.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

Applicants have discovered that embodiments described herein may be particularly useful in connection with insurance policies associated with automobile accidents. Note, however, that other types of insurance policies may also benefit from the invention. For example, embodiments of the present invention may be used in connection with motorcycle, marine, airplane insurance policies, etc.

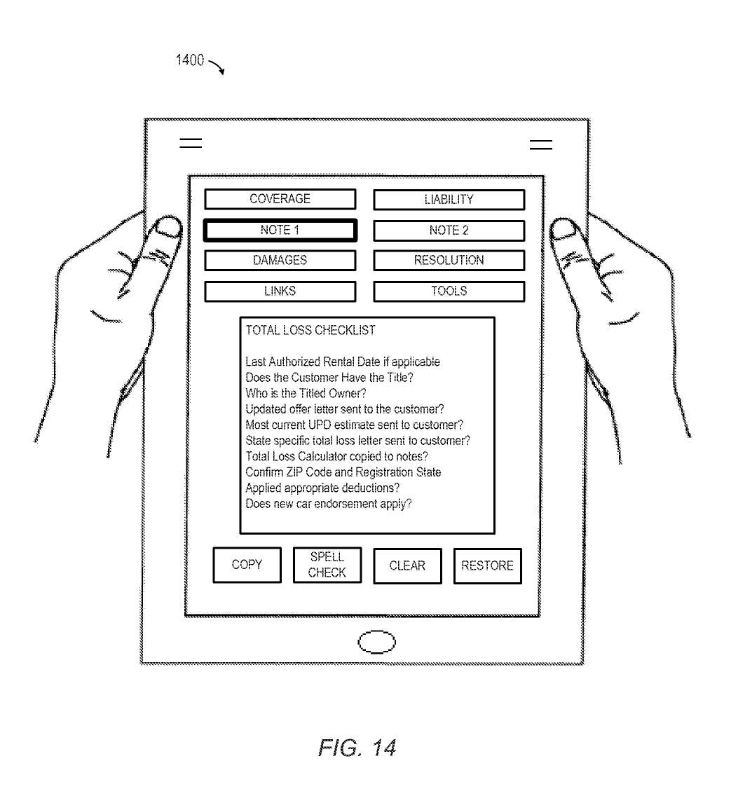

Moreover, some embodiments have been described herein as being accessed via a PC or laptop computer. Note, however, that embodiments may be implemented using any device capable of executing the disclosed functions and steps. For example, FIG. 14 illustrates a display 1400 in accordance with some embodiments described herein. In particular, the display 1400 includes a graphical user interface including information about note interface of an automobile insurance resource tool.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system for facilitating entry of automobile insurance claim data, comprising:
a communication device to receive input data from a claim professional, the input data being associated with an automobile insurance claim;
a computer processor for executing program instructions; and
a memory, coupled to the computer processor, for storing program instructions for execution by the computer processor for:
interacting with the claim professional via a graphical user interface tool to receive compliance information via a regulation compliance checklist interface,
automatically creating action plan information based on the received compliance information, and
displaying an indication of the action plan information to the claim professional via a compliance issue area in a resolution interface of the graphical user interface tool.

2. The system of claim 1, wherein the input data received from the claim professional includes a geographic location associated with the automobile claim, and the memory further stores instructions to execution by the computer processor for:
automatically determining a coverage issue based at least in part on the geographic location associated with the automobile insurance claim and at least one coverage rule, and
displaying an indication of the determined coverage issue to the claim professional via the graphical user interface tool

3. The system of claim 2, wherein the geographic location comprises at least one of an insurance policy state or an accident state.

4. The system of claim 1, wherein the graphical user interface tool includes an automobile insurance coverage interface to receive from the claim professional at least two of: (i) personal insurance information, (ii) commercial insurance information (iii) policy status effective date, (iv) vehicle information, (v) coverage limits, (vi) a driver status, (vii) applicable endorsement information, and (vii) coverage notes.

5. The system of claim 4, the memory further stores instructions to execution by the computer processor for:
automatically creating additional action plan information based on the received automobile insurance coverage interface information, and
displaying an indication of the additional action plan information to the claim professional via a coverage issue area in a resolution interface of the graphical user interface tool.

6. The system of claim 1, wherein the graphical user interface tool includes an automobile insurance liability interface to receive from the claim professional at least two of: (i) a preliminary/final liability indication, (ii) facts of loss, (iii) an applicable indication of state law, (iv) a description of another party's negligence, (v) a description of an insured's negligence, and (vi) a first liability percentage.

7. The system of claim 6, the memory further stores instructions to execution by the computer processor for:
automatically creating additional action plan information based on the received automobile insurance liability interface information, and
displaying an indication of the additional action plan information to the claim professional via a liability issue area in a resolution interface of the graphical user interface tool.

8. The system of claim 1, wherein the graphical user interface tool includes an automobile insurance damages interface to receive from the claim professional at least two of: (i) a description of injuries and cause, (ii) a description of occupation and work status, (iii) a description of incurred and future treatments, and (iv) a reserve assessment.

9. The system of claim 8, the memory further stores instructions to execution by the computer processor for:
automatically creating additional action plan information based on the received automobile insurance damages interface information, and
displaying an indication of the additional action plan information to the claim professional via a damages issue area in a resolution interface of the graphical user interface tool.

10. The system of claim 1, wherein the resolution interface to receive from the claim professional at least two of: (i) a coverage status, (ii) a description of coverage issues, (iii) a compliance status, (iv) a description of compliance requirements, (v) a liability status, (vi) a description of liability issues, (vii) a damages status, (viii) a description of damages issues and associated timeframes for resolution, (ix) vehicle passenger information, (x) a litigation plan status, and (xi) a description of litigation plan issues.

11. The system of claim 1, wherein the graphical user interface tool includes an automobile insurance links interface to receive from the claim professional an indication of a geographic region and to provide to the claim professional: (i) links to resources associated with the indicated geographic region, and (ii) links to country-wide resources.

12. The system of claim 1, wherein the graphical user interface tool includes an automobile insurance resource tools interface to interact with the claim professional in connection with at least one of: (i) a date calculator, (ii) a rental cost calculator, and (iii) an uninsured motorist property damage coverage calculator.

13. The system of claim 1, wherein the graphical user interface tool includes an automobile insurance first note interface to receive from the claim professional a template selection and to provide to the claim professional an insurance note template based on the template selection.

14. The system of claim 13, wherein the graphical user interface tool includes a second note interface independent of the first note interface.

15. The system of claim 13, wherein information in the first note interface is automatically populated with data received from the claim professional via other interfaces of the graphical user interface tool.

16. The system of claim 13, wherein the claims profession interacts with the first note interface to copy information to an external claim processing application.

17. A computer-implemented method for facilitating entry of automobile insurance claim data, comprising:
interacting, at a computer processor of an automobile insurance resource platform, with a claim professional via a graphical user interface tool;
receiving input data from the claim professional, the input data being associated with an automobile insurance claim and including compliance information received via a regulation compliance checklist interface;
automatically creating, by the computer processor of the automobile insurance resource platform, action plan information based on the received compliance information; and
displaying an indication of the action plan information to the claim professional via a compliance issue area in a resolution interface of the graphical user interface tool.

18. The method of claim 17, wherein the graphical user interface tool includes: (i) an automobile insurance first note interface to receive from the claim professional a template selection and to provide to the claim professional an insurance note template based on the template selection, and (ii) a second note interface independent of the first note interface.

19. The method of claim 18, wherein the claims profession interacts with the first note interface to copy information to an external claim processing application.

20. A non-transitory computer-readable medium storing instructions adapted to be executed by a computer processor to perform a method for facilitating entry of automobile insurance claim data, said method comprising:
interacting, at a computer processor of an automobile insurance resource platform, with a claim professional via a graphical user interface tool;
receiving input data from the claim professional, the input data being associated with an automobile insurance claim and including compliance information received via a regulation compliance checklist interface;
automatically creating, by the computer processor of the automobile insurance resource platform, action plan information based on the received compliance information; and
displaying an indication of the action plan information to the claim professional via a compliance issue area in a resolution interface of the graphical user interface tool.

21. The medium of claim 20, wherein the graphical user interface tool includes: (i) an automobile insurance first note interface to receive from the claim professional a template selection and to provide to the claim professional an insurance note template based on the template selection, and (ii) a second note interface independent of the first note interface.

22. The medium of claim 21, wherein the claims profession interacts with the first note interface to copy information to an external claim processing application.
